(19) United States
(12) Patent Application Publication
(10) Pub. No.: US 2024/0112448 A1
(43) Pub. Date: Apr. 4, 2024

(54) METHODS AND SYSTEMS OF GENERATING IMAGES UTILIZING MACHINE LEARNING AND EXISTING IMAGES WITH DISENTANGLED CONTENT AND STYLE ENCODING

(71) Applicants: Robert Bosch GmbH, Stuttgart (DE); CARNEGIE MELLON UNIVERSITY, Pittsburgh, PA (US)

(72) Inventors: Mansur ARIEF, Verona, PA (US); Ji Eun KIM, Pittsburgh, PA (US); Shashank SHEKHAR, Ranchi (IN); Mohammad Sadegh NOROUZZADEH, Pittsburgh, PA (US); Ding ZHAO, Pittsburgh, PA (US)

(21) Appl. No.: 17/949,517

(22) Filed: Sep. 27, 2022

(51) Int. Cl. G06V 10/774; G06F 16/532; G06T 11/00; G06V 10/764; G06V 10/82; G06V 20/58

(52) U.S. Cl. CPC G06V 10/774; G06F 16/532; G06T 11/00; G06V 10/764; G06V 10/82; G06V 20/582

(57) ABSTRACT

Systems and methods for generating new images for training a machine-learning model are disclosed. Image data is produced regarding an image captured by an image sensor. The image data is altered such that the style of the image (e.g., color, shading, orientation, etc.) is altered. The altered image data is encoded into a first latent space. An image from a database is selected based on its similarity to the altered image and a decoding of the first latent space. Style encodings of the first latent space are extracted to classify a style of the altered image data in a second latent space. New images are then generated utilizing a reconstructor model that combines the two latent spaces. These new images can be used to train an image-recognition model.

### TECHNICAL FIELD

The present disclosure relates to methods and systems of generating images utilizing machine learning and existing images. In particular embodiments, this disclosure relates to realistic road sign generation from road sign prototypes with disentangled content and style encoding using machine learning models.

### BACKGROUND

Image classification is the process of categorizing and labeling an image based on its contents. Machine learning (e.g., deep learning) is typically utilized for this process. Machine learning for image classification has evolved to be extremely accurate in classifying various objects in images as belonging to a particular class. This is particularly true for images showing objects belonging to classes that are common. However, the accuracy of the image classifier can suffer for certain classes that are rare or previously unseen. In other words, when the classifier has been trained with only a limited number of objects belonging to a particular class (or none at all), the classifier may not accurately label the particular pixels or vectors as belonging to the correct class.

### SUMMARY

According to an embodiment, a method of generating images for training a machine-learning mode includes: receiving image data corresponding to an image captured by an image sensor; altering the image data corresponding to a style of the image to create altered image data; utilizing a machine-learning model to encode the altered image data into a first latent space; retrieving, from a database, a prototype image that represents the altered image data based on a decoding of the first latent space; extracting style encodings from the first latent space to classify a style of the altered image data in a second latent space; and generating a new image utilizing a pre-trained reconstructor model that combines the first latent space and the second latent space.

According to another embodiment, a system of generating images for training a machine-learning model includes an image sensor configured to capture an image and generate image data corresponding to the captured image. The system also includes a processor in communication with the image sensor and programmed to: alter a portion of the image data corresponding to a style of the image to create altered image data; encode, via a machine-learning model, the altered image data into a first latent space; decode the first latent space and retrieve, from a database, a prototype image that represents the altered image based on the decoded first latent space; extract style encodings from the first latent space to classify a style of the altered image data in a second latent space; and generate a new image utilizing a pre-trained reconstructor model that combines the first latent space and the second latent space.

According to another embodiment, a method of training a machine-learning model with newly generated images to yield a trained machine-learning model includes: receiving image data corresponding to an image captured by an image sensor; altering a portion of the image data corresponding to a style of the image, wherein the altering produces altered image data; encoding the altered image data into a first latent space; selecting, from a database, a prototype image that corresponds to the altered image based on a decoding of the first latent space; extracting style encodings from the first latent space to classify a style of the altered image data in a second latent space; generating a new image utilizing a pre-trained reconstructor model that combines the first latent space and the second latent space; and training an image-recognition machine-learning model using the new image generated from the pre-trained reconstructor model to yield a trained image-recognition machine-learning model.

### BRIEF DESCRIPTION OF THE DRAWINGS

FIG. 1 shows a system for training a machine-learning model, in this case a neural network, according to an embodiment.

FIG. 2 shows a computer-implemented method for training and utilizing a neural network, according to an embodiment.

FIG. 3A shows a schematic of an embodiment of the disclosed image generation machine-learning model, in this case a road sign generator, according to an embodiment.

FIG. 3B shows an inference pipeline for the image generation machine-learning model of FIG. 3A, according to an embodiment.

FIG. 4 shows a schematic of a deep neural network with nodes in an input layer, multiple hidden layers, and an output layer, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MM apparatus, x-ray imaging apparatus or ultrasonic apparatus.

FIG. 12 illustrates a flow chart of a method for generating images utilizing existing images and the machine learning described herein.

FIG. 13 illustrates an overview of applying the image generation described herein in the form of a road sign generator that generates images for use in an AI-assisted labeling tool for training a model, and/or in a real-time road sign detection and classification system, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Modern deep learning classifiers requires an abundance of data to train. However, many available datasets are highly imbalanced. For instance, the German Traffic Sign Recognition Dataset, or German Traffic Sign Benchmark (GTSRB) contains more than 50,000 images of 43 types of traffic signs have a few types that dominate the majority of the images. For example, of the 50,000 stored images in the GTSRB, around 3,000 of the images relate to a 50 kilometer per hour (kph) speed limit, and another approximately 2,900 of the images relate to a 30 kph speed limit. Meanwhile, there are many traffic signs that are underrepresented in the GTSRB, or not included at all in this dataset.

From a real-world application perspective, this may be highly problematic. For instance, consider deploying an autonomous vehicle that uses a traffic sign classifier trained using this dataset. The vehicle must be able to use the trained classifier to recognize all kinds of traffic signs that can be encountered during driving so that the vehicle can make a safe decisions, especially when the sign suggests interactions with other road users. However, the problem of imbalanced images in the database suggests that there are many important signs that have only a few samples in the dataset. Examples of these signs include pedestrian (only 500 samples) or turn straight left (only 300 samples). Road signs that seem to be rare in the database nonetheless play a critical role in driving and safety in an autonomous vehicle, and therefore requires minimal false negatives.

Many state of the art traffic sign predictions and classifiers have achieved an accuracy of over 85%, with some common classes of signs achieving more than 98% accuracy. Traffic sign prediction models and classifiers perform better when more images are available in the underlying training dataset. This results in a more robust data for training the models. But it may be impossible to collect real-world images for every single traffic sign type, and from various angles, lighting, and background sceneries that would lead to a robust dataset.

Therefore, according to various embodiments described herein, methods and systems are provided for generating synthetic yet realistic traffic sign images from the existing templates or prototype images. Machine learning is utilized to generate new images in order to balance the sample size of images across classes in the training set. In other words, this disclosure seeks a robust way to generate realistic traffic signs and use them as a data augmentation tool to improve classifier performance, especially for rare traffic signs.

Earlier work has attempted to generate realistic traffic sign images using methods that achieve high performance on generating faces. But for road signs, unlike faces, the “contents” of the image are essentially categorical and only the styles vary in wide spectrum. This adds complexity to the task, because to achieve realistic traffic sign images, the model could not simply combine arbitrary features from images of one class to the other. The model has to be able to disentangle the features attributed to the content of the images and features attributed to the style. This suggests that the model should either have high capacity for disentanglement or be designed in a specific way allowing it to learn image contents and styles separately.

To achieve this, the systems disclosed herein synthesize a model that achieves high-accuracy for zero-shot classification task, with content-and-style decoupling mechanisms. The system can learn the compact latent representation of the sign which can be used to categorize seen classes as well as detect unseen classes. The decoupling mechanism uses soft labels that capture the various styles that explain the real-world images, e.g. brightness, blurriness, rotation, deformation, etc. By training a second latent space for classifying the image styles, the latent codes from both spaces are passed to a high-capacity reconstructor to generate an image with content from the first space and style from the second space. This approach allows the generation of realistic images for both common and uncommon/unseen classes so long as the prototype of the target image is accessible. More importantly, the generated images can be used for data augmentation, improving the classifier accuracy for unseen classes.

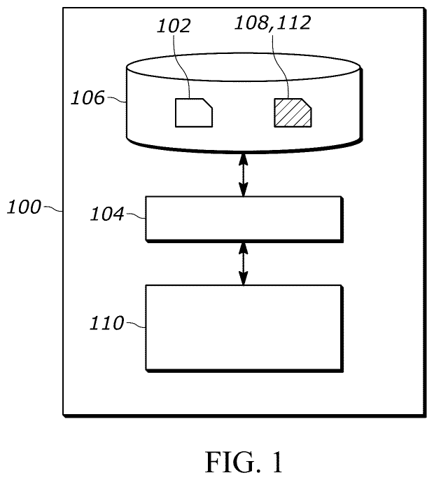

Below, a more detailed disclosure of these methods and systems is provided. But first, reference is made to FIG. 1 which can apply these teachings to a machine learning model or neural network. FIG. 1 shows a system 100 for training a neural network, e.g., a deep neural network. The system 100 may comprise an input interface for accessing training data 102 for the neural network. The training data may be, for example, image data, and more particularly, image data relating to road signs. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

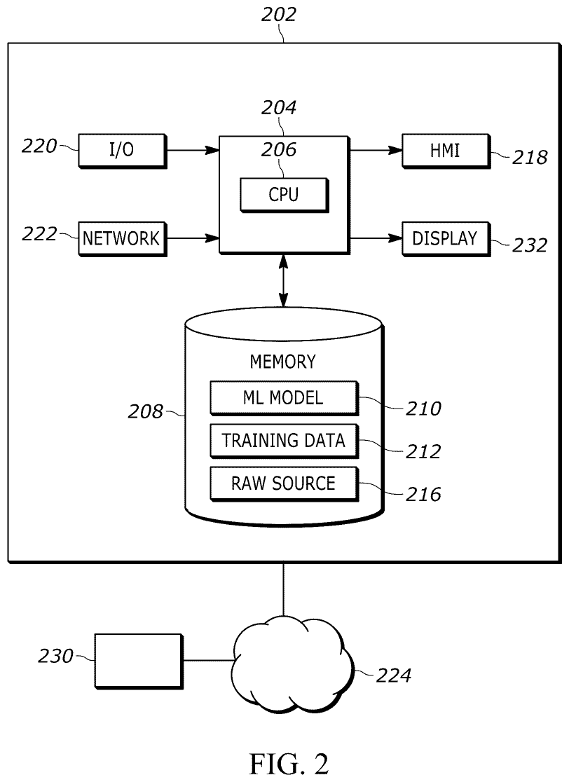

The structure of the system 100 is one example of a system that may be utilized to train the machine-learning models described herein. Additional structure for operating and training the machine-learning models is shown in FIG. 2.

FIG. 2 depicts a system 200 to implement the machine-learning models described herein, for example the image generation machine-learning model, the reconstructor machine-learning model, and the pre-trained reference model described herein. The system 200 can be implemented to perform the generation of road sign images described herein in order to increase the amount of images available for the training of the image-recognition systems implemented on vehicles, for example. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor, e.g. image sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

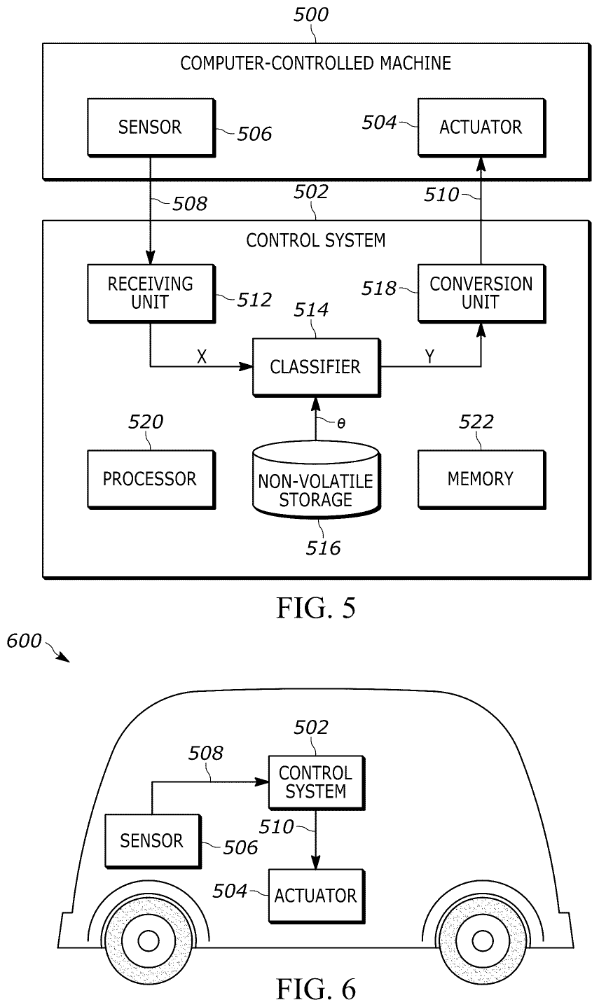

The system 200 may implement one or more machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). While many references in this disclosure are provided to applying the disclosed systems for improving road sign recognition models, the teachings provided herein can be provided in many different settings; several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs in images captured from image sensors such as cameras. The machine-learning algorithm(s) 210 may include algorithms configured to operate the machine-learning models disclosed herein such as the image generation machine-learning model, the reconstructor model, and the like.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to generate new images of road signs based on previously-stored images in the database. The machine-learning algorithm 210 may be programmed to process the raw source data 216 (e.g., images that include road signs) to identify the presence of the particular features (e.g., the road signs themselves, along with the surrounding shading, lighting, etc.). The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image of a road sign. Applying the machine-learning algorithms described herein (e.g., image generation machine-learning model, reconstructor model, etc.), the output can be a new, reconstructed image of the road sign having different characteristics such as different color, shading, blurriness, brightness, contrast, angle or orientation of the road sign, to name a few. The newly-generated image can be stored in the database of road sign images for improvement of road-sign detection machine-learning models.

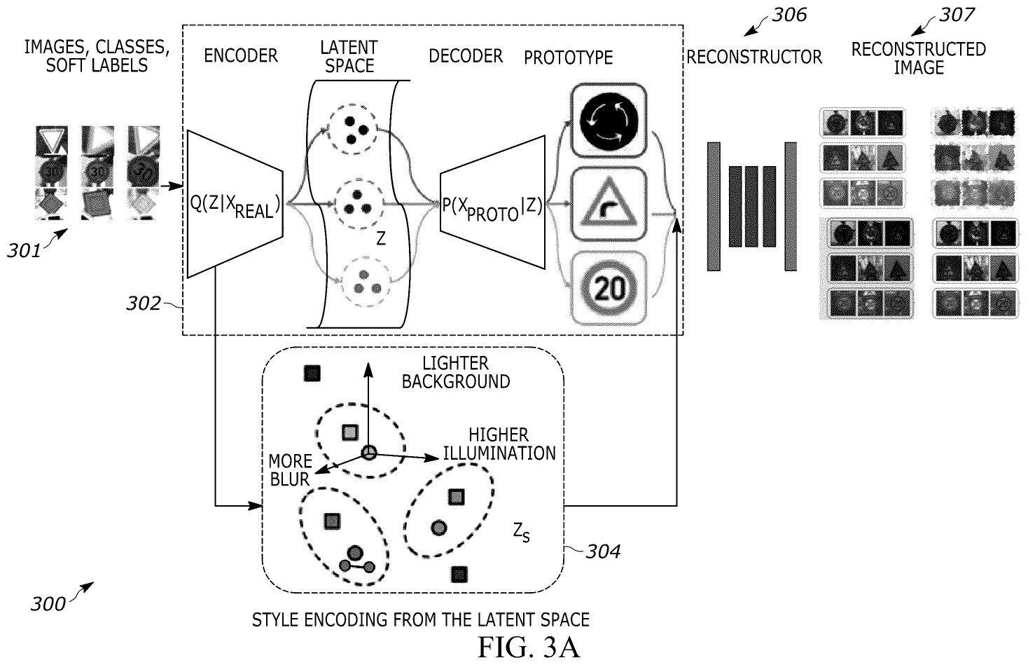

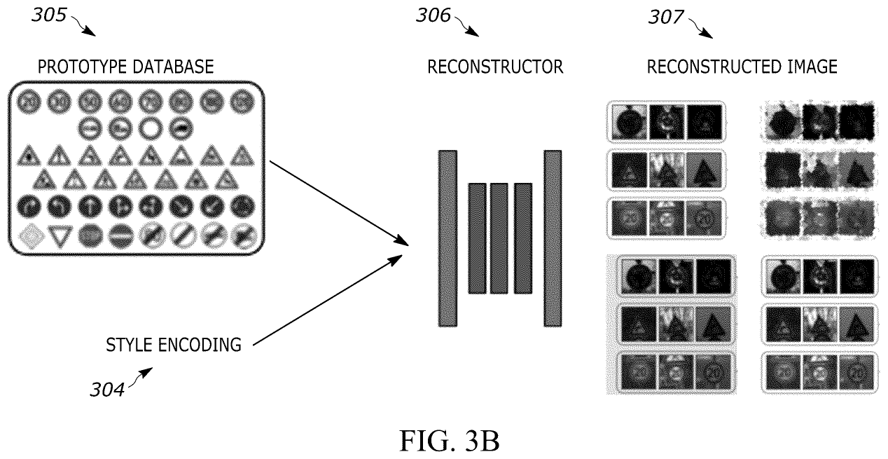

Given the above description of the machine-learning models, along with the structural examples of FIGS. 1-2 configured to carry out the models, FIG. 3A illustrates a flow chart of the architecture and training pipeline for the image generation machine-learning model 300, and FIG. 3B illustrates an inference pipeline for the image generation machine-learning model. The image generation machine-learning model 300 can also be referred to as a road sign generator in embodiments where the model 300 is used to generate images of road signs. The flow chart of FIG. 3A illustrates the model 300 as an end-to-end learnable image generation machine-learning model. Real captured images 301 (e.g., of road signs) are used as input. The image generation machine-learning model 300 includes a variational prototype encoding (VPE) model 302 configured to reconstruct or select traffic sign prototypes based on input real-world images 301, a content and style decoupling model 304 configured to classify the style of the input images from the latent space, and a pre-trained reconstructor model 306 configured to combine the latent space from both models 302, 304 to generate new synthetic images 307 as output that can then be added to the database of images used to train a separate image-recognition machine-learning model 300. These models are merely examples of types of machine-learning models that may be used. For example, the VPE model 302 is a type of machine-learning model that encodes image data into latent space, and other machine-learning models suited for this purpose can be utilized.

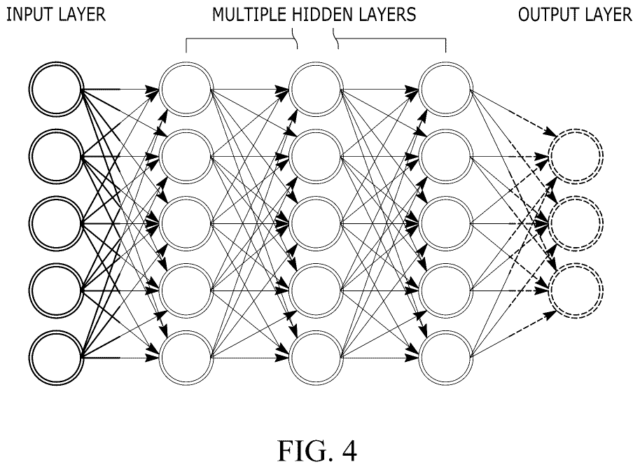

FIG. 4 illustrates a schematic of a machine-learning model (e.g., deep neural network). As discussed above, the image generation machine-learning model 300 and its various models within (e.g., VPE model 302, content and style decoupling model 304, and pre-trained reconstructor model 306) can be arranged as a deep neural network shown in FIG. 4. It should be understood that this is merely exemplary, and the models may take the form of other machine-learning models. The model(s) can include an input layer (having a plurality of input nodes) and an output layer (having a plurality of output nodes). In some examples, the model(s) may include a plurality of hidden layers. The nodes of the input layer, output layer, and hidden layers may be coupled to nodes of subsequent or previous layers. And each of the nodes of the output layer may execute an activation function—e.g., a function that contributes to whether the respective nodes should be activated to provide an output of the model(s). The quantities of nodes shown in the input, hidden, and output layers are merely exemplary and any suitable quantities may be used.

Returning to FIG. 3A, real-world images are input at 301 into the image generation machine-learning model 300. These images may be originally captured from images sensors (e.g., cameras) installed on an autonomous or semi-autonomous vehicle, for example. The images can either be fed into the image generation machine-learning model 300 in real-time as the images are captured via wireless communication (e.g., network 222). Alternatively, the images may be input into the image generation machine-learning model 300 from storage, e.g., in a batch format. The input into the VPE model 302 may also include images with varying styles of the original images. For example, the orientation, size, color, shading, brightness, contrast, etc. of the original captured images may be altered and fed into the VPE model 302 in batch format as well.

In general, the VPE model 302 is configured to model in the latent space Z to encode the content of the input images. As will be described, the reconstructor 306 is appended to the VPE model 302, and a second latent space Z_{S} in the model 304 encodes the styles of the input images. The VPE model 302 encodes the real-world image instances x to some latent representation z, which is then converted into a prototype image. In doing so, the VPE model 302 performs image-to-image translation using a variational auto encoder (VAE) structure, converting noisy real-world traffic sign images into clean, canonical images. In other words, the VPE model 302 selects a prototype image that corresponds to the real-world image based on the classification (e.g., encoder-decoder architecture). The prototype image can be an image stored in storage, selected based on the output of the classification. The selected or produced prototype image is then an input into the reconstructor 306 described herein.

The training process of the VPA model 302 takes dataset D={(xᵢ, tᵢ)}ᵢ₌₁^{N}, including N pairs of traffic sign image xᵢ∈X and its prototype image tᵢ∈T, i=1, . . . , N. The latent code zᵢ∈Z is sampled from a prior distribution p₇₄ (z). The prototype tᵢ is then generated from a conditional distribution p_{θ}(t|z). Then, the likelihood of the lower bound of the marginal log is computed for each individual prototype log p_{θ}(tᵢ) as follows:

$$log {p}_{θ} ( t ) = log ( {𝔼}_{{q}_{ϕ} ( Z \vert X )} \frac{p ( t , z )}{{q}_{ϕ} ( Z \vert X )} ) \geq {𝔼}_{{q}_{ϕ} ( Z \vert X )} [ log {p}_{θ} ( t \vert z ) ] - {D}_{KL} [ {q}_{ϕ} ( z \vert x ) , {p}_{θ} ( z ) ] \qquad ( 1 )$$

where q_{ϕ}(z|x) is the proposal distribution that approximates the true posterior, and D_{KL}(·, ·) is the KL-divergence. Also, q_{ϕ} and p_{θ} are referred to as a probabilistic encoder and decoder, respectively. The encoder and decoder functions are labeled as such within the VPE model 302 in FIG. 3A. The training process for the VPE model 302 is made efficient through a reparameterization trick to minimize empirical loss:

$${ℒ}_{VPE} ( θ , ϕ ) = \frac{1}{{N}_{b}} {\sum }_{i = 1}^{{N}_{b}} - log {p}_{θ} ( {t}_{i} , {z}_{i} ) + {D}_{KL} [ {q}_{ϕ} ( {z}_{i} \vert {x}_{i} ) , {p}_{θ} ( {z}_{i} ) ] \qquad ( 2 )$$

using stochastic gradient descent or methods with momentum over minibatch D_{b}={(xᵢ, tᵢ)}ᵢ₌₁^{N}^{_{b}} of size N_{b} constructed using the original dataset D.

After training, the VPE model 302, functionally represented as f=(f_{θ}, f_{ϕ}), can be used as a zero-shot classifier, by passing through traffic sign images and prototype images through the encoder f_{θ}: X→Z and performing nearest neighbor classifier on the latent space Z. If the latent code for instances of traffic sign images are too far from the latent code of the prototypes, then the model 302 considers them as novel classes. In other words, if the latent space data is beyond a threshold from one of the prototype images, the model considers this traffic sign image as a new class of image not yet stored in the database. In this regard, the latent space Z encodes the information required to reconstruct a prototype image, and therefore has extracted the important features that robustly distinguishes the noisy traffic sign images for different classes.

For such a zero-shot classification task, a VPE decoder f_{ϕ}:Z→T may not be utilized. For generating realistic traffic sign images, this decoder is repurposed and the whole pipeline is restricted, another latent space Z_{S} (in content and style decoupling model 304) added that is configured to extract the styles of the images regardless of their class, and synthesize it with the latent code Z that encodes the information regarding the content of the traffic sign. Additional detail regarding this is described with reference to the content and style decoupling model 304 below.

The encoder f_{θ} can use convolution layers with batch normalization and leaky ReLU activations. This structure follows Idsia network that has been shown to capture the features of traffic sign images for classifications very well. Following these convolutional layers is fully connected layer to get the latent encodings; the network can include multiple convolutional layers each followed by a leaky ReLU activation function and a batchnorm layer. Then, after all the convolutional layers, one fully connected layer can be provided that outputs the final codes.

As described above, this disclosure includes a modification of a VPE structure in the VPE model 302 to append a reconstructor f_{ρ} 306 following the VPE decoder f_{ϕ}, as well as latent space for styles Z_{S} within a content and style decoupling model 304 in order to extract the style representation of real-world traffic images. This requires soft labels as part of the input in the training process to learn the mapping f_{θ}_{ₛ}: X→Z, that disentangles the styles (e.g., lighting conditions, blurriness, illumination, deformation and other transformations, etc.). The parameters of the model is therefore ω=[θ, θₛ, ϕ, ρ].

To achieve this, a contrastive loss and a perceptual loss are used to encourage the final reconstructed image 307 denoted as \hat{x}=f_{ρ}(t, f_{θ}_{ₛ} (x)) to be as realistic as possible but having varying styles. It should be noted that t=_{ϕ}(f_{θ}(x)). Contrastive loss is computed for each sample in the training minibatch D_{b}:

[symbol]

_{cont}(ω)=Σ_{∀x}_{ᵢ}ₓ_{ⱼ}_{∈D}_{_{b}}_{,i≠j}yᵢⱼdᵢⱼ²+(1−yᵢⱼ)max(γ−dᵢⱼ,0)² (3)

where yᵢⱼ is the indicator function whether samples xᵢ and xⱼ are of the same class, dᵢⱼ is some measure of distance between the reconstructed image \hat{x}ᵢ and \hat{x}ⱼ, and γ is the distance threshold for being considered similar. The perceptual loss can be computed using VGG16 layers g:

$${ℒ}_{perc} ( ω ) = \frac{1}{CHW} {‖ g ( {x}_{i} ) - g ( {\hat{x}}_{i} ) ‖}_{2}^{2} \qquad ( 4 )$$

where C, H, and W are the dimension of the feature g(·).

Finally, realisticity of the reconstructed image \hat{x} is encouraced by using non-realisticity penalty [symbol] ᵣₑₐₗ(ω)=ϕ(\hat{x}). The overall training loss can be expressed as the weighted combination of these losses:

[symbol]

(ω)=α₁ [symbol] _{VPE}+α₂ [symbol] _{cont}+α₃ [symbol] _{perct}+α₄ [symbol] ᵣₑₐₗ (5)

The weights α=[α₁, . . . , α₄] are the hyperparameters for the model. Similar optimization approaches used for the VPE model 302 can be used to minimize the overall loss of the model 300.

Referring to FIG. 3B, according to an embodiment, after training of the model 300, all that is required to generate new images of traffic signs at 307 are: (1) data representing one or more sign prototypes t, which can be obtained from a traffic sign database (such as the GTSRB) 305, and (2) the style encoding from the content and style decoupling model 304, which can be obtained by passing an image x through the encoder and collecting only the style encoding f_{θ}_{ₛ}(x) or by randomly sampling the style latent space Zs. These ingredients (t, zₛ) are then passed through the trained reconstructor f_{ρ} 316.

The machine-learning models described herein can be used in many different applications, and not just in the context of road-sign generation. Additional applications where image generation may be used are shown in FIGS. 6-11. Structure used for training and using the machine-learning models for these applications (and other applications) are exemplified in FIG. 5, and the application of the trained machine-learning models is shown in FIGS. 6-11. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include image, video, radar, LiDAR, ultrasonic and motion sensors. In one embodiment, sensor 506 is an optical sensor (e.g., camera) configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning algorithm, such as a neural network described above. Classifier 514 may be a zero-shot classifier such as described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y. The actuator 504 may be a command to store the data associated with the classification task.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to zero-shot classifier) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Once trained, the models described herein can be applied in a variety of settings. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of road-sign recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects (e.g., road signs) in the vicinity of vehicle 600 dependent on input signals x. In such an embodiment, output signal y may include information characterizing the objects to vehicle 600 (e.g., a sign informing a speed limit of 50 kph). Actuator control command 510 may be determined in accordance with this information. The actuator control command 510 may be used to avoid collisions with the detected objects. The actuator control command 510 may be a command to reduce the speed of the vehicle corresponding to the information from output signal y indicating a speed limit of 50 kph.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

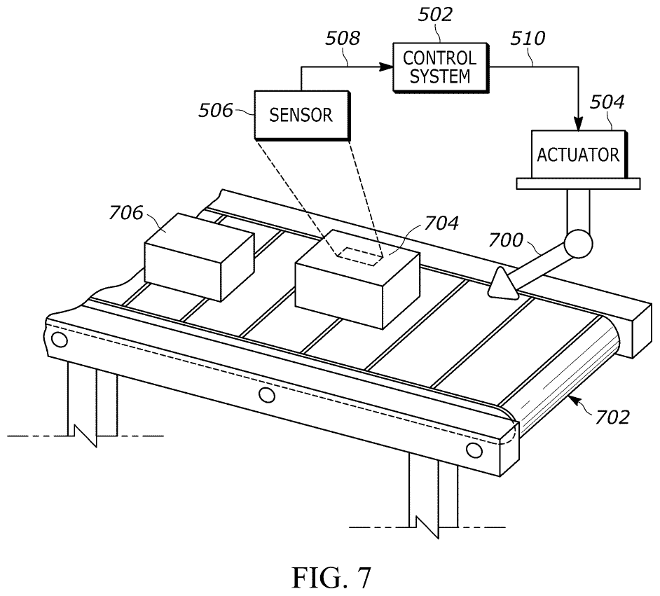

While the above disclosure includes road sign generation and subsequent road sign detection, the teachings herein can be applied to other image generation and detection settings. Generating new synthetic images to create a more robust machine-learning dataset can be useful in a variety of applications where image recognition and classification is utilized. FIGS. 7-11 illustrate examples of other such applications. For example, FIG. 7 depicts a schematic diagram of control system 502 configured to control a system 700 embodied as a manufacturing machine (e.g., a punch cutter, a cutter or a gun drill) of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

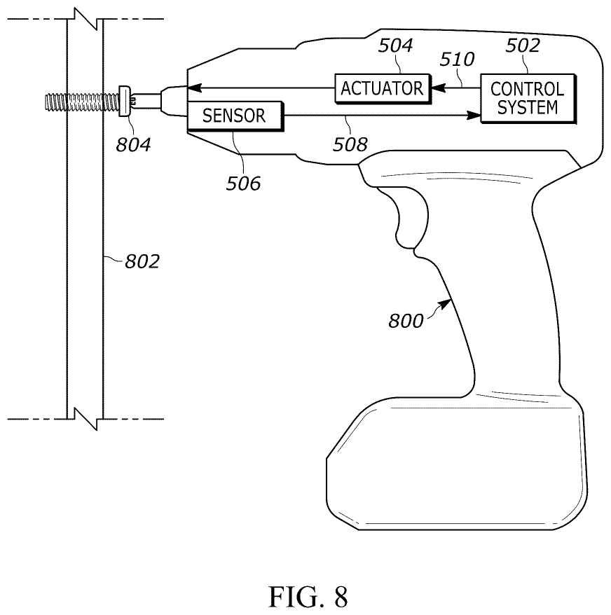

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

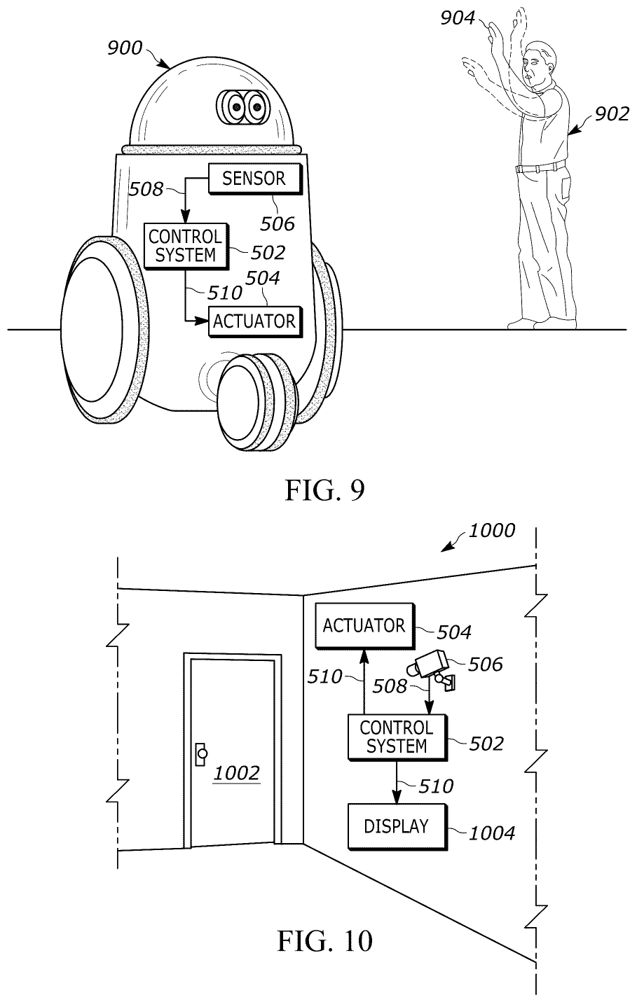

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

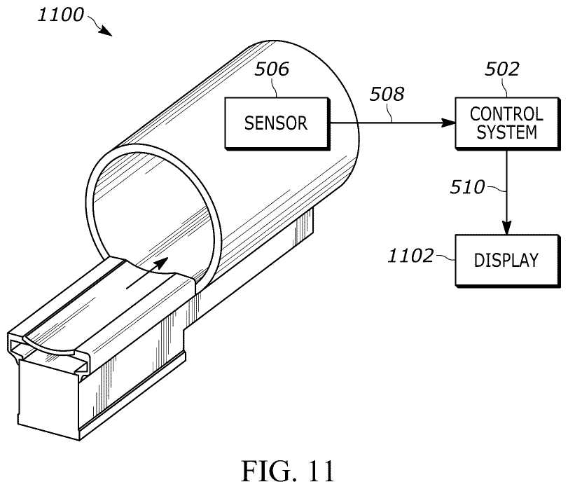

FIG. 11 depicts a schematic diagram of control system 502 configured to control imaging system 1100, for example an Mill apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

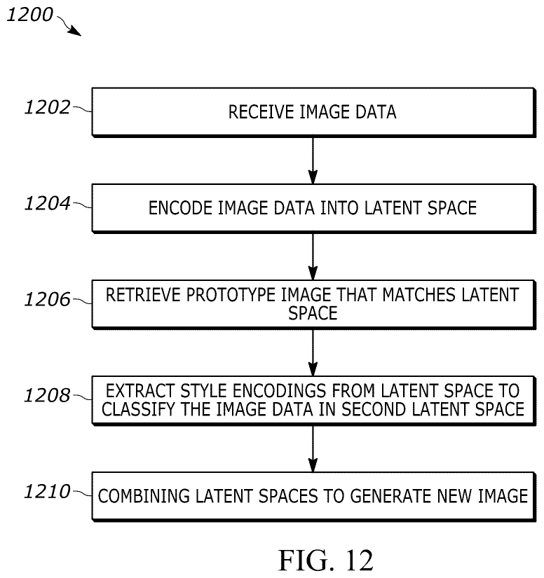

FIG. 12 illustrates a flowchart 1200 of an algorithm (which may include one or more algorithms within) implemented by one or more processors described herein. The method may be performed for a certain type or class of image that is not relatively prevalent in the machine-learning dataset; e.g., rare image classes. For example, a road sign indicating a speed limit of 20 kph may not be relatively prevalent in the entire machine-learning database (e.g., GTSRB). This 20 kph sign type or class may be selected for the method illustrated in FIG. 12 to generate additional images for use in training a corresponding image recognition machine-learning model. The selection of the image for the method may be done manually, or may be done by the one or more processors based on a threshold; for example, the image may be selected based on the corresponding image class being below a threshold percentage of the entire dataset (e.g., GTSRB).

At 1202, image data is received by the one or more processors. The image data can be data representing the input images, such as images 301, e.g. real-world images of traffic signs for example. At 1204, the one or more processors encodes the image data into a latent space. This can be performed using the VPE model 302, for example, which is configured to encode the content of the real-world images in the latent space.

At 1206, the one or more processors retrieves a prototype image from a database that most closely resembles the latent space representation of the input image data. This can be a comparison of latent space of the input image data to the latent space of the prototype images stored in the database. This can be performed using the VPE model 302, for example, which performs image-to-image translation using a VAE structure, converting noisy real-world traffic sign images into clean, canonical images.

At 1208, the one or more processors is programmed to extract style encodings from the latent space that was encoded at 1204. This can be performed utilizing a content and style decoupling model 304, configured to decouple the style of the image from the content of the image. The model can be used to classify the image data into a second latent space, comprising style indicators (e.g., blurriness, brightness, illumination, angle or orientation, etc.) originating in the first latent space.

At 1210, the one or more processors is programmed to combine the first latent space and the second latent space (e.g., via a pre-trained reconstructor model 306) to create a new image. The new image has an appearance of the original input image, but with different styles. These new images can be fed into another model (e.g., image recognition machine-learning model) for training the model with new, additional images of objects that appear an imbalanced number of times in data (e.g., rare).

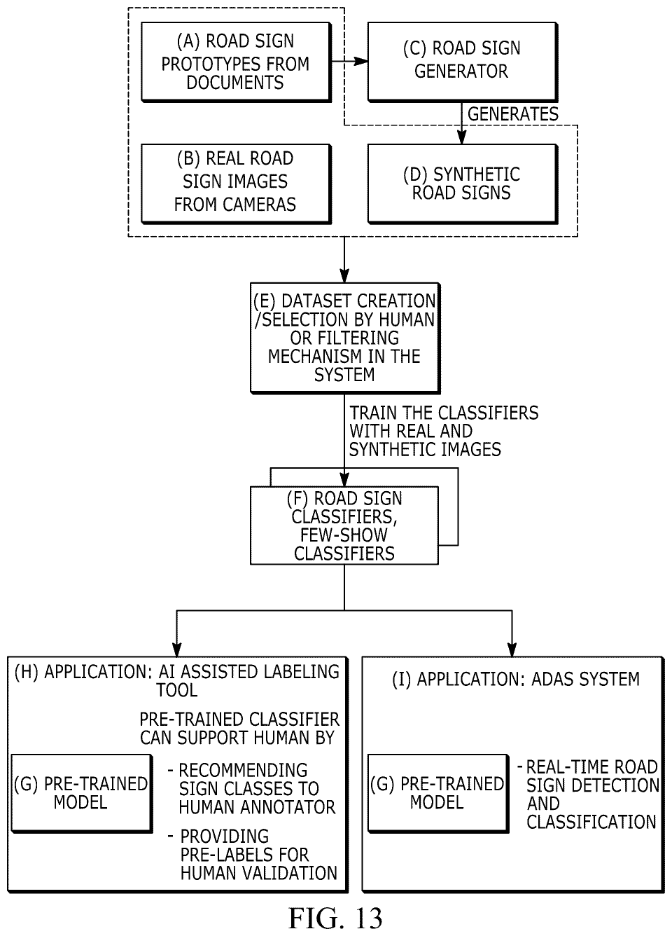

FIG. 13 illustrates a flowchart of a process of the data augmentation disclosed herein, and its applications. Road sign prototypes (A) can be obtained from government documents or the Internet as various image formats such as PNG, JPEG, SVG, etc. These road sign prototypes are used as inputs to the road sign generator (C), also referred to more generally as an image generation machine-learning model such as the one illustrated in FIG. 3A and described above. This road sign generator is trained to generate synthetic road sign images (D), such as the new images 307 described above. The real sign images (B) (e.g., input images 301) and the synthetic road sign images (D), along with the road sign prototypes (A), a few-shot classifier (F) (e.g., VPE and road sign classifiers described above) can be used. The synthetic road signs (D) can be optionally filtered at (E) by a human or other filtering mechanism implemented into the system to select the best quality (e.g., most realistic) synthetic sign and create class-balanced training datasets.

The resulting newly generated images have several applications, such as those described above, and two of which are shown at (H) and (I). At (H), an AI-assisted labeling tool can leverage pre-trained models (G) to assist human annotators to reduce their cognitive load by recommending road sign classes or by asking human annotators to validate the machine prediction (e.g., human-in-loop). At (I), an Advanced Driver Assistance Systems (ADAS) or other autonomous driving or semi-autonomous driving system can improve its performance by training with the models described herein with the additional images generated from the road sign generator. Road signs which have not yet been observed (or have only been observed a limited number of times) can cause the image-recognition system in the ADAS system to lack in training, causing the system to incorrectly classify a new image captured from a camera during travel. These newly generated road signs can help train the models used in these ADAS systems such that the models are trained with more data, giving a more robust performance of the model.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of generating images for training a machine-learning model, the method comprising:
receiving image data corresponding to an image captured by an image sensor;
altering the image data corresponding to a style of the image to create altered image data;
utilizing a machine-learning model to encode the altered image data into a first latent space;
retrieving, from a database, a prototype image that represents the altered image data based on a decoding of the first latent space;
extracting style encodings from the first latent space to classify a style of the altered image data in a second latent space; and
generating a new image utilizing a pre-trained reconstructor model that combines the first latent space and the second latent space.

2. The method of claim 1, further comprising:
training an image-recognition machine-learning model using the new image generated from the pre-trained reconstructor model to produce a trained image-recognition machine-learning model.

3. The method of claim 1, wherein the first latent space includes the style encodings and categorical content encodings, and wherein the second latent space does not include the categorical content encodings.

4. The method of claim 1, wherein the style encodings include data representing blurriness of the image, orientation of the image, brightness of the image, or deformation of the image.

5. The method of claim 1, wherein:
the image sensor is mounted on a vehicle,
the image captured is of a road sign, and
the generated new image differs in style from the captured image of the road sign.

6. The method of claim 1, wherein the pre-trained reconstructor model utilizes a contrastive loss and a perceptual loss when generating the new image.

7. The method of claim 1, further comprising:
selecting the image data for utilization with the machine-learning model based upon a relative prevalence of a corresponding image class in a machine-learning database.

8. A system of generating images for training a machine-learning model, the system comprising:
an image sensor configured to capture an image and generate image data corresponding to the captured image; and
a processor in communication with the image sensor and programmed to:
alter a portion of the image data corresponding to a style of the image to create altered image data,
encode, via a machine-learning model, the altered image data into a first latent space,
decode the first latent space and retrieve, from a database, a prototype image that represents the altered image based on the decoded first latent space,
extract style encodings from the first latent space to classify a style of the altered image data in a second latent space, and
generate a new image utilizing a pre-trained reconstructor model that combines the first latent space and the second latent space.

9. The system of claim 8, wherein the processor is further programmed to:
train an image-recognition machine-learning model using the new image generated from the pre-trained reconstructor model to produce a trained image-recognition machine-learning model.

10. The system of claim 8, wherein the first latent space includes the style encodings and categorical content encodings, and wherein the second latent space does not include the categorical content encodings.

11. The system of claim 8, wherein the style encodings include data representing blurriness of the image, orientation of the image, brightness of the image, or deformation of the image.

12. The system of claim 8, wherein:
the image sensor is mounted on a vehicle,
the image captured is of a road sign, and
the generated new image differs in style from the captured image of the road sign.

13. The system of claim 8, wherein the pre-trained reconstructor model utilizes a contrastive loss and a perceptual loss when generating the new image.

14. The system of claim 8, wherein the processor is further programmed to:
select the image data for utilization with the machine-learning model based upon a relative prevalence of a corresponding image class in a machine-learning database.

15. A method of training a machine-learning model with newly generated images to yield a trained machine-learning model, the method comprising:
receiving image data corresponding to an image captured by an image sensor;
altering a portion of the image data corresponding to a style of the image, wherein the altering produces altered image data;
encoding the altered image data into a first latent space;
selecting, from a database, a prototype image that corresponds to the altered image based on a decoding of the first latent space;
extracting style encodings from the first latent space to classify a style of the altered image data in a second latent space;
generating a new image utilizing a pre-trained reconstructor model that combines the first latent space and the second latent space; and
training an image-recognition machine-learning model using the new image generated from the pre-trained reconstructor model to yield a trained image-recognition machine-learning model.

16. The method of claim 15, wherein the first latent space includes the style encodings and categorical content encodings, and wherein the second latent space does not include the categorical content encodings.

17. The method of claim 15, wherein the style encodings include data representing blurriness of the image, orientation of the image, brightness of the image, or deformation of the image.

18. The method of claim 15, wherein:
the image sensor is mounted on a vehicle,
the image captured is of a road sign, and
the generated new image differs in style from the captured image of the road sign.

19. The method of claim 15, wherein the pre-trained reconstructor model utilizes a contrastive loss and a perceptual loss when generating the new image.

20. The method of claim 15, further comprising:
selecting the image data for utilization with the machine-learning model based upon a relative prevalence of a corresponding image class in a machine-learning database.
